(19) United States
(12) Patent Application Publication
(10) Pub. No.: US 2024/0234867 A1
(43) Pub. Date: Jul. 11, 2024

(54) HEAT TRANSFER FLUID FOR THERMAL MANAGEMENT, THERMAL MANAGEMENT DEVICE AND BATTERY THERMAL MANAGEMENT SYSTEM

(71) Applicant: INDUSTRIAL TECHNOLOGY RESEARCH INSTITUTE, Hsinchu (TW)

(72) Inventors: Yung-Jen CHENG, Hsinchu City (TW); Ya-Chi HO, New Taipei City (TW); Po-Chih CHEN, New Taipei City (TW); En-Lan HU, Hsinchu City (TW); Tsai-Liang WU, Zhubei City (TW)

(73) Assignee: INDUSTRIAL TECHNOLOGY RESEARCH INSTITUTE, Hsinchu (TW)

(21) Appl. No.: 18/126,852

(22) Filed: Mar. 27, 2023

(30) Foreign Application Priority Data
Jan. 6, 2023 (TW) 112100588

(51) Int. Cl. H01M 10/6567; B60H 1/00; B60H 1/32; H01M 10/613; H01M 10/6552

(52) U.S. Cl. CPC H01M 10/6567; B60H 1/00278; B60H 1/00392; B60H 1/3202; H01M 10/613; H01M 10/6552

(57) ABSTRACT

The present disclosure provides a heat transfer fluid for thermal management includes a liquid carrier and a gas generation substance. The gas generation substance is distributed in the liquid carrier. The gas generation substance includes at least one of two-dimensional nanomaterial and three-dimensional nanomaterial. The present disclosure also provides a thermal management device and a battery thermal management system having the heat transfer fluid.

### CROSS-REFERENCE TO RELATED APPLICATIONS

This application claims priority under 35 U.S.C. § 119(a) on Patent Application No(s). 112100588 filed in Taiwan, R.O.C. on Jan. 6, 2023, the entire contents of which are hereby incorporated by reference.

### TECHNICAL FIELD

The present disclosure is related to a heat transfer fluid for thermal management, a thermal management device and a battery thermal management system.

### BACKGROUND

With the development of clean energy, new energy vehicles (NEVs) will gradually replace traditional fuel vehicles. Lithium batteries, as a widely known power source for NEVs, are affected by temperature in terms of charging and discharging efficiency, capacity, safety and service life. If the battery temperature is overly high or low, it will lead to the degradation of battery performance, making the system fail prematurely or even cause fire and explosion accidents. Therefore, an effective thermal management for lithium batteries is an important issue to be solved in this technical field.

At present, the thermal management for a battery pack consisting of multiple lithium cells includes, but not limited to, air thermal management, liquid thermal management, and phase change material thermal management. Since the liquid thermal management features high thermal conductivity and high heat exchange rate, it is helpful to achieve uniform temperature distribution of the battery pack.

Recently, due to the increasing demand for heat exchange efficiency, a thermal management configuration including additional heat pipe(s) in a liquid cooling system has attracted extensive attention.

### SUMMARY

According to one embodiment of the present disclosure, a heat transfer fluid for thermal management includes a liquid carrier and a gas generation substance. The gas generation substance is distributed in the liquid carrier. The gas generation substance includes at least one of two-dimensional nanomaterial and three-dimensional nanomaterial.

According to another embodiment of the present disclosure, a thermal management device includes a pulsating heat pipe and a heat transfer fluid. The heat transfer fluid is provided in the pulsating heat pipe, and the heat transfer fluid includes a liquid carrier and a gas generation substance. The gas generation substance is distributed in the liquid carrier. The gas generation substance includes at least one of two-dimensional nanomaterial and three-dimensional nanomaterial.

According to still another embodiment of the present disclosure, a battery thermal management system includes a battery container, a pulsating heat pipe and a heat transfer fluid. The pulsating heat pipe is disposed in the battery container. The heat transfer fluid is provided in the pulsating heat pipe, and the heat transfer fluid includes a liquid carrier and a gas generation substance. The gas generation substance is distributed in the liquid carrier and includes nanomaterial.

### BRIEF DESCRIPTION OF THE DRAWINGS

FIG. 1 is a perspective view of a battery thermal management system according to a first embodiment of the present disclosure;

FIG. 2 is a cross sectional view of the battery thermal management system along a line 2-2 in FIG. 1;

FIG. 3 is a perspective view of a battery thermal management system according to a second embodiment of the present disclosure;

FIG. 4 is a perspective view of a battery thermal management system according to a third embodiment of the present disclosure;

FIG. 5 is a perspective view of a battery thermal management system according to a fourth embodiment of the present disclosure;

FIG. 6 is a perspective view of a battery thermal management system according to a fifth embodiment of the present disclosure;

FIG. 7 is a perspective view of a battery thermal management system according to a sixth embodiment of the present disclosure;

FIG. 8 is a graph showing flow velocities of the heat transfer fluids in a pulsating heat pipe according to the first embodiment and a comparative example;

FIG. 9 is a graph showing the temperature in different positions of the battery thermal management system in FIG. 1 with the heat transfer fluid according to the first embodiment in the pulsating heat pipe; and

FIG. 10 is a graph showing the temperature in different positions of the battery thermal management system in FIG. 1 with the heat transfer fluid according to the comparative example in the pulsating heat pipe.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present disclosure. The following embodiments further illustrate various aspects of the present disclosure, but are not meant to limit the scope of the present disclosure.

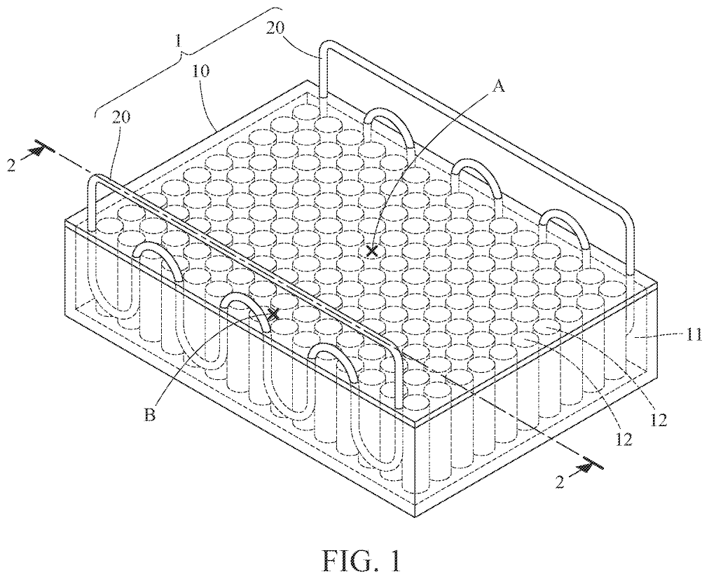

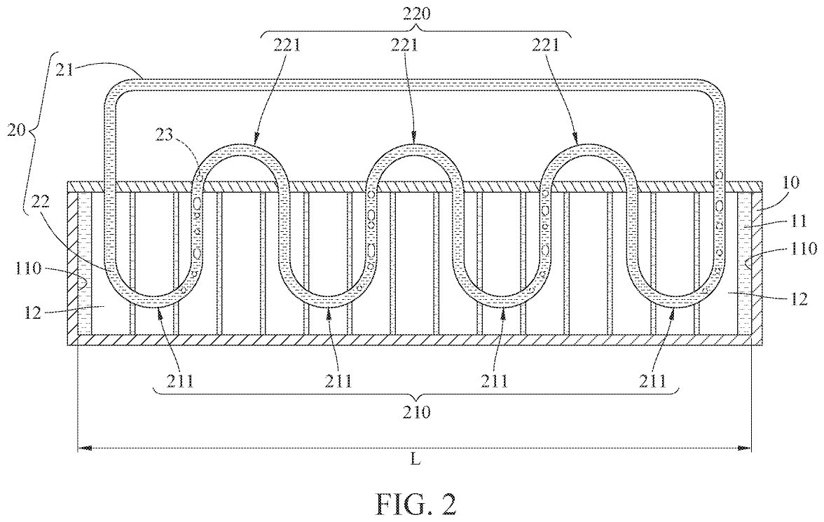

According to one embodiment of the present disclosure, a battery thermal management system may include a battery container, a pulsating heat pipe and a heat transfer fluid. Please refer to FIG. 1 and FIG. 2. FIG. 1 is a perspective view of a battery thermal management system according to a first embodiment of the present disclosure, and FIG. 2 is a cross sectional view of the battery thermal management system along a line 2-2 in FIG. 1. The battery thermal management system 1 includes a battery container 10 and a thermal management device 20. The thermal management device 20 includes a pulsating heat pipe 21 and a heat transfer fluid 22. The pulsating heat pipe 21 is disposed on the battery container 10, and the heat transfer fluid 22 is provided in the pulsating heat pipe 21. The pulsating heat pipe 21 may be made of metal, such as pure copper, stainless steel (SUS304) or aluminum (Al6061). Moreover, the heat transfer fluid 22 may occupy 40% to 75% of the internal space of the heat pipe 21.

According to one embodiment of the present disclosure, the pulsating heat pipe may be submerged in a coolant in the battery container. As shown in FIG. 2, the pulsating heat pipe 21 includes an evaporation section 210 and a condensation section 220. The evaporation section 210 is located in the battery container 10, and the condensation section 220 protrudes out of the battery container 10. A coolant 11 is provided in the battery container 10, and thus the evaporation section 210 is submerged in the coolant 11. The battery container 10 can accommodate a plurality of battery cells 12, and the battery cells 12 may be submerged in the coolant 11. The coolant 11 is, for example but not limited to, paraffin or ethylene glycol, and each of the battery cells 12 is, for example but not limited to, a lithium battery cell.

The heat generated by the battery cells 12 can be transferred to the pulsating heat pipe 21 through the coolant 11. The heat transfer fluid 22 in the pulsating heat pipe 21 absorbs heat and vaporizes to form multiple bubbles 23 (or vapor plugs) so as to increase the pressure in the evaporation section 210, thereby pushing the heat transfer fluid 22 to move toward the condensation section 220. The vaporized heat transfer fluid 22 at the condensation section 220 condenses into liquid state and forms one or more liquid slugs, thus creating a capillary phenomenon in the pulsating heat pipe 21 and causing the condensed heat transfer fluid 22 to flow back to the evaporation section 210. By back and forth of the heat transfer fluid 22 between the evaporation section 210 and the condensation section 220, the heat exchange can be achieved to dissipate heat from the battery cells 12.

According to one embodiment of the present disclosure, the pulsating heat pipe may include a plurality of bends at the evaporation section. As shown in FIG. 2, the pulsating heat pipe 21 may be located between two inner side walls 110 of the battery container 10, and the pulsating heat pipe 21 includes a plurality of bends 211 at the evaporation section 210. When a dimensionless spacing between the two inner side walls 110 is L′, and the number of the bends 211 at the evaporation section 210 is Ne, the following condition is satisfied: Ne≤ L′/2. Herein, L′ is defined as “the distance between the two inner side walls 110 L (unit of Length)/1 (unit of Length.)”. Also, FIG. 1 and FIG. 2 exemplarily depict the pulsating heat pipe 21 including a total of four bends 211 at the evaporation section 210.

According to one embodiment of the present disclosure, the pulsating heat pipe may include a plurality of bends at the condensation section. As shown in FIG. 2, the pulsating heat pipe 21 includes a plurality of bends 221 at the condensation section 220. When the dimensionless spacing between the two inner side walls 110 is L′, and the number of the bends 221 at the condensation section 220 is Nc, the following condition is satisfied: Nc≤L′/2. FIG. 1 and FIG. 2 exemplarily depict the pulsating heat pipe 21 including a total of three bends 221 at the condensation section 220.

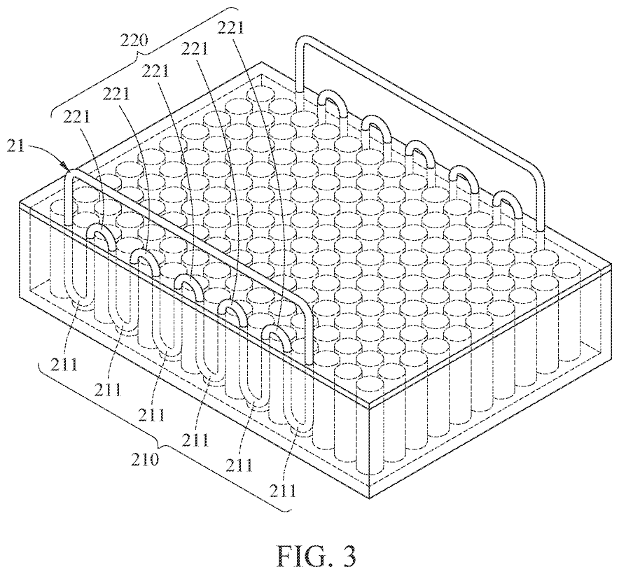

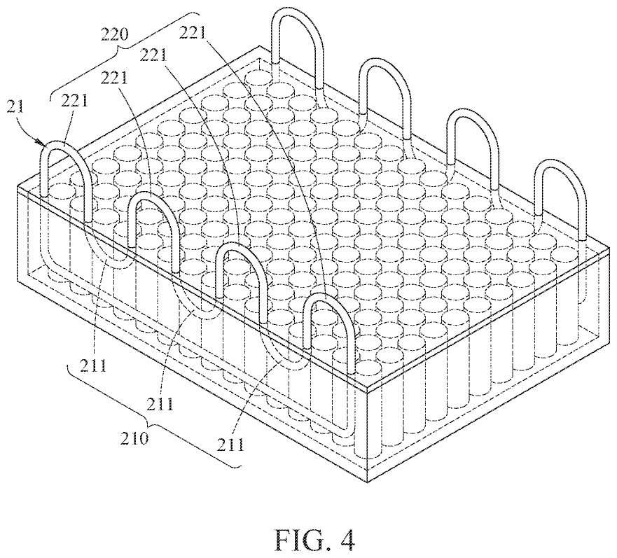

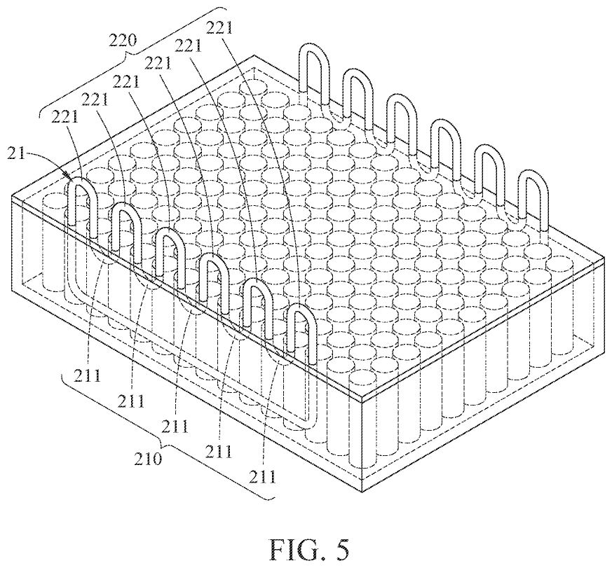

The present disclosure is not limited by the number of the bends 211 and 221 shown in FIG. 1 and FIG. 2, respectively. Referring to FIG. 3 which is a perspective view of a battery thermal management system according to a second embodiment of the present disclosure. Herein, the pulsating heat pipe 21 includes a total of six bends 211 at the evaporation section 210 as well as a total of five bends 221 at the condensation section 220. Referring to FIG. 4 which is a perspective view of a battery thermal management system according to a third embodiment of the present disclosure. Herein, the pulsating heat pipe 21 includes a total of three bends 211 at the evaporation section 210 as well as a total of four bends 221 at the condensation section 220. Referring to FIG. 5 which is a perspective view of a battery thermal management system according to a fourth embodiment of the present disclosure. Herein, the pulsating heat pipe 21 includes a total of five bends 211 at the evaporation section 210 as well as a total of six bends 221 at the condensation section 220. The heat transfer fluid 22 may be provided in each of the pulsating heat pipes 21 in FIG. 3 through FIG. 5.

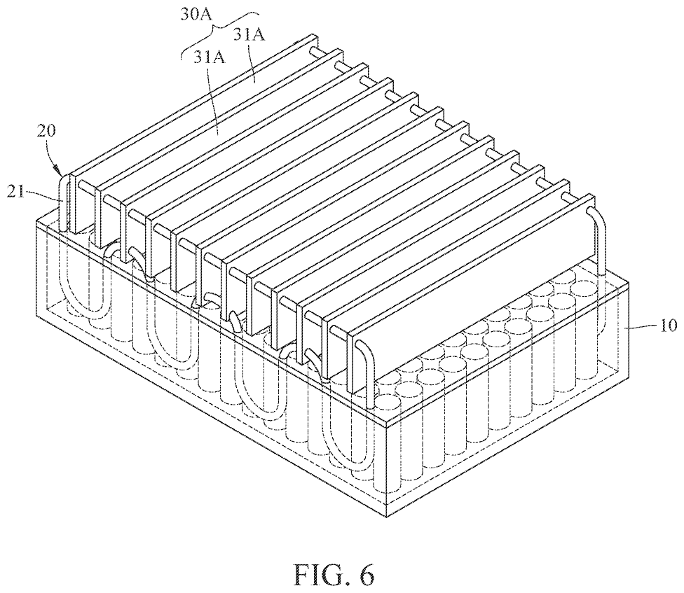

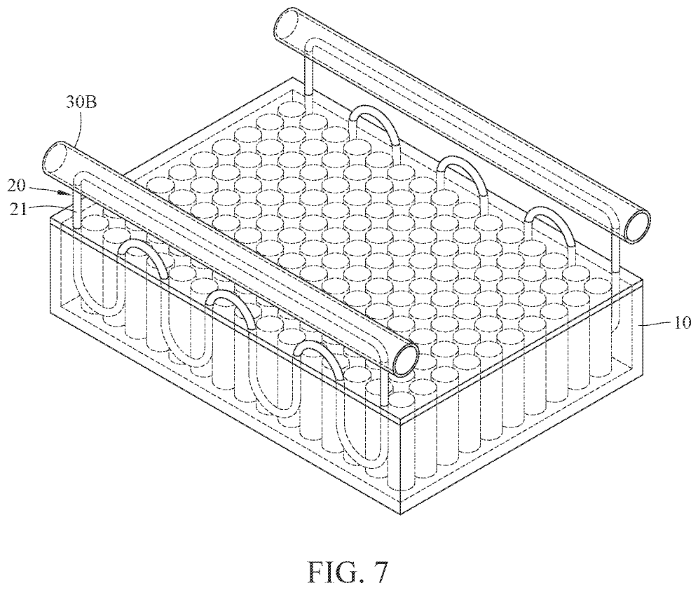

According to one embodiment of the present disclosure, the battery thermal management system may further include a heat sink. Please refer to FIG. 6 and FIG. 7. FIG. 6 is a perspective view of a battery thermal management system according to a fifth embodiment of the present disclosure, and FIG. 7 is a perspective view of a battery thermal management system according to a sixth embodiment of the present disclosure. As shown in FIG. 6, the battery thermal management system includes a battery container 10, a thermal management device 20 and a heat sink 30A. The heat sink 30A includes a plurality of fins 31A in thermal contact with the pulsating heat pipe 21 of the thermal management device 20. As shown in FIG. 7, the battery thermal management system includes a battery container 10, a thermal management device 20 and a heat sink 30B. The heat sink 30B includes a heat pipe in thermal contact with the pulsating heat pipe 21 of the thermal management device 20. A coolant, such as cooling water, air or nitrogen gas, may be provided in the heat sink 30B. The additional heat sinks 30A and 30B is helpful to further enhance the heat dissipation efficiency. Each of the pulsating heat pipes 21 in FIG. 6 and FIG. 7 may be provided with the heat transfer fluid 22 in FIG. 2 therein.

According to one embodiment of the present disclosure, the heat transfer fluid may include a gas generation substance. Specifically, the heat transfer fluid 22 in FIG. 2 may include a liquid carrier and a gas generation substance. The gas generation substance is distributed in the liquid carrier, and the gas generation substance includes nanomaterials for gas generation. The liquid carrier may be selected from the group consisting of pure water (deionized water), methanol, acetone, ammonia, and combinations thereof. Since the heat exchange of the pulsating heat pipe 21 relies on the bubbles or vapor plugs formed by the vaporization of the liquid carrier in the heat transfer fluid 22 to push the rest of the liquid carrier, the generation rate of the bubbles will affect the heat exchange efficiency of the pulsating heat pipe 21. According to one embodiment of the present disclosure, the gas generation substance is helpful to generate a large amount of bubbles or vapor plugs in the heat transfer fluid 22 within a short period of time, thereby facilitating the heat exchange efficiency of the pulsating heat pipe 21.

The gas generation substance may include a first nanomaterial, and the first nanomaterial includes at least one of two-dimensional nanomaterial and three-dimensional nanomaterial. Specifically, a suitable two-dimensional nanomaterial meets the requirements of single atomic layer thickness and planar shape, such as graphene. Also, a suitable three-dimensional nanomaterial meets the requirement that the dimensions of length, width and height are all in nanometer scale.

The gas generation substance may include at least one of graphene and carbon black. Specifically, said graphene refers to graphene nanowires, graphene nanorods, graphene nanotubes, or graphene nanoribbons. Said carbon black refers to graphite nano-sheets having a thickness of more than two carbon atomic layers. The selection of graphene or carbon black is helpful to simultaneously meet the requirements of high production rate of bubbles or vapor plugs and high thermal conductivity.

A mass percentage concentration of the gas generation substance in the heat transfer fluid 22 may range from 0.001 wt % to 5.0 wt %. In one embodiment, the mass percentage concentration of the gas generation substance in the heat transfer fluid 22 may range from 0.05 wt % to 1.2 wt %. In another embodiment, the mass percentage concentration of the gas generation substance in the heat transfer fluid 22 may range from 0.4 wt % to 1.0 wt %. Herein, the mass percentage concentration of the gas generation substance in the heat transfer fluid 22 may be, for example, 0.05 wt %, 0.1 wt %, 0.3 wt %, 0.4 wt %, 0.45 wt %, 0.5 wt %, 0.75 wt % or 1.0 wt %.

A mass percentage concentration of the first nanomaterial in the heat transfer fluid 22 may range from 0.001 wt % to 5.0 wt %. In one embodiment, the mass percentage concentration of the first nanomaterial in the heat transfer fluid 22 may range from 0.05 wt % to 1.2 wt %. In another embodiment, the mass percentage concentration of the first nanomaterial in the heat transfer fluid 22 may range from 0.4 wt % to 1.0 wt %. Herein, the mass percentage concentration of the first nanomaterial in the heat transfer fluid 22 may be, for example, 0.05 wt %, 0.1 wt %, 0.3 wt %, 0.4 wt %, 0.45 wt %, 0.5 wt %, 0.75 wt % or 1.0 wt %.

A mass percentage concentration of graphene or carbon black in the heat transfer fluid 22 may range from 0.001 wt % to 5.0 wt %. In one embodiment, the mass percentage concentration of graphene or carbon black in the heat transfer fluid 22 may range from 0.05 wt % to 1.2 wt %. In another embodiment, the mass percentage concentration of graphene or carbon black in the heat transfer fluid 22 may range from 0.4 wt % to 1.0 wt %. Herein, the mass percentage concentration of graphene or carbon black in the heat transfer fluid 22 may be, for example, 0.05 wt %, 0.1 wt %, 0.3 wt %, 0.4 wt %, 0.45 wt %, 0.5 wt %, 0.75 wt % or 1.0 wt %.

When the mass percentage concentration of the gas generation substance in the heat transfer fluid 22 is no less than 0.05 wt % or no less than 0.4 wt %, the amount of bubbles or vapor plugs is sufficient for accelerating the flow of the heat transfer fluid 22. When the mass percentage concentration of the gas generation substance in the heat transfer fluid 22 is no more than 1.2 wt % or no more than 1.0 wt %, it is favorable for preventing viscous heat transfer fluid 22 due to excessive gas generation substance, and thus easy to flow.

In addition to the aforementioned two-dimensional nanomaterial and/or three-dimensional nanomaterial, the gas generation substance may further include a second nanomaterial for the auxiliary of heat transfer. The second nanomaterial may be metal oxide nanomaterial or silicon nanomaterial. Herein, the second nanomaterial may be aluminum oxide nanoparticles, copper oxide nanoparticles, iron oxide nanoparticles or silicon nanoparticles.

The mass percentage concentration of the first nanomaterial in the heat transfer fluid 22 may be greater than a mass percentage concentration of the second nanomaterial in the heat transfer fluid 22. In one embodiment, the mass percentage concentration of the second nanomaterial in the heat transfer fluid 22 may range from 0.001 wt % to 0.5 wt %. Herein, the mass percentage concentration of the second nanomaterial in the heat transfer fluid 22 may be, for example, 0.05 wt %, 0.1 wt %, 0.2 wt % or 0.5 wt %.

According to one embodiment of the present disclosure, the heat transfer fluid 22 includes the first nanomaterial and the second nanomaterial, but the present disclosure is not limited thereto. In some other embodiments, the heat transfer fluid 22 may include only the first nanomaterial, which means that only graphene or carbon black is presented in the liquid carrier.

The technical effects of the heat transfer fluid disclosed in the present disclosure will be illustrated by specific embodiments hereafter.

### Embodiment 1

A heat transfer fluid 22 in a pulsating heat pipe 21 according to any embodiment of the present disclosure is provided. The heat transfer fluid 22 includes pure water as a liquid carrier, graphene as a first nanomaterial, and aluminum oxide as a second nanomaterial. The mass percentage concentration of graphene in the heat transfer fluid 22 is 0.5 wt %. The mass percentage concentration of aluminum oxide in the heat transfer fluid 22 is 0.1 wt %.

### Embodiment 2

A heat transfer fluid 22 in a pulsating heat pipe 21 according to any embodiment of the present disclosure is provided. The heat transfer fluid 22 includes pure water as a liquid carrier, graphene as a first nanomaterial, and copper oxide as a second nanomaterial. The mass percentage concentration of graphene in the heat transfer fluid 22 is 0.5 wt %. The mass percentage concentration of copper oxide in the heat transfer fluid 22 is 0.05 wt %.

### Embodiment 3

A heat transfer fluid 22 in a pulsating heat pipe 21 according to any embodiment of the present disclosure is provided. The heat transfer fluid 22 includes pure water as a liquid carrier, and graphene as well as carbon black as a first nanomaterial. The mass percentage concentration of graphene in the heat transfer fluid 22 is 0.45 wt %. The mass percentage concentration of carbon black in the heat transfer fluid 22 is 0.05 wt %.

### Embodiment 4

A heat transfer fluid 22 in a pulsating heat pipe 21 according to any embodiment of the present disclosure is provided. The heat transfer fluid 22 includes pure water as a liquid carrier, and graphene as a first nanomaterial. The mass percentage concentration of graphene in the heat transfer fluid 22 is 0.5 wt %.

### Embodiment 5

A heat transfer fluid 22 in a pulsating heat pipe 21 according to any embodiment of the present disclosure is provided. The heat transfer fluid 22 includes pure water as a liquid carrier, and graphene as a first nanomaterial. The mass percentage concentration of graphene in the heat transfer fluid 22 is 0.75 wt %.

### Embodiment 6

A heat transfer fluid 22 in a pulsating heat pipe 21 according to any embodiment of the present disclosure is provided. The heat transfer fluid 22 includes pure water as a liquid carrier, and graphene as a first nanomaterial. The mass percentage concentration of graphene in the heat transfer fluid 22 is 1.0 wt %.

### Embodiment 7

A heat transfer fluid 22 in a pulsating heat pipe 21 according to any embodiment of the present disclosure is provided. The heat transfer fluid 22 includes pure water as a liquid carrier, graphene as a first nanomaterial, and silicon as a second nanomaterial. The mass percentage concentration of graphene in the heat transfer fluid 22 is 0.5 wt %. The mass percentage concentration of silicon in the heat transfer fluid 22 is 0.05 wt %.

### Embodiment 8

A heat transfer fluid 22 in a pulsating heat pipe 21 according to any embodiment of the present disclosure is provided. The heat transfer fluid 22 includes pure water as a liquid carrier, graphene as well as carbon black as a first nanomaterial, and aluminum oxide as a second nanomaterial. The mass percentage concentration of graphene in the heat transfer fluid 22 is 0.4 wt %. The mass percentage concentration of carbon black in the heat transfer fluid 22 is 0.1 wt %. The mass percentage concentration of aluminum oxide in the heat transfer fluid 22 is 0.1 wt %.

### Embodiment 9

A heat transfer fluid 22 in a pulsating heat pipe 21 according to any embodiment of the present disclosure is provided. The heat transfer fluid 22 includes pure water as a liquid carrier, carbon black as a first nanomaterial, and aluminum oxide as well as iron oxide as a second nanomaterial. The mass percentage concentration of carbon black in the heat transfer fluid 22 is 0.3 wt %. The mass percentage concentration of aluminum oxide in the heat transfer fluid 22 is 0.1 wt %. The mass percentage concentration of iron oxide in the heat transfer fluid 22 is 0.1 wt %.

### Embodiment 10

A heat transfer fluid 22 in a pulsating heat pipe 21 according to any embodiment of the present disclosure is provided. The heat transfer fluid 22 includes pure water as a liquid carrier, carbon black as a first nanomaterial, and iron oxide as well as silicon as a second nanomaterial. The mass percentage concentration of carbon black in the heat transfer fluid 22 is 0.3 wt %. The mass percentage concentration of iron oxide in the heat transfer fluid 22 is 0.1 wt %. The mass percentage concentration of silicon in the heat transfer fluid 22 is 0.1 wt %.

### Comparative Example

Pure water in a pulsating heat pipe 21 according to any embodiment of the present disclosure is provided. There is no nanomaterial in the water.

The mass percentage concentration of nanomaterial in the heat transfer fluid, the maximum heat flux of the heat transfer fluid, and the heat transfer coefficient of the heat transfer fluid in each embodiment (EM) and comparative example can be referred to TABLE 1 below.

TABLE 1

| | | | | | | | Heat |
|---|---|---|---|---|---|---|---|
| | | | | | | Maximum | transfer |
| | Liquid | First | | Second | | heat flux | coefficient |
| | carrier | nanomaterial | | nanomaterial | | (W/m²) | (W/m · k) |
| Comparative | Pure water | None | | None | | 50 | 8000 |
| Example | | | | | | | |
| EM 1 | Pure water | Graphene | 0.5 | aluminum | 0.1 | 125 | 26000 |
| | | | wt % | oxide | wt % | | |
| EM 2 | Pure water | Graphene | 0.5 | Copper | 0.05 | 105 | 16000 |
| | | | wt % | oxide | wt % | | |
| EM 3 | Pure water | Graphene | 0.45 | None | | 105 | 15000 |
| | | | wt % | | | | |
| | | Carbon | 0.05 | | | | |
| | | black | wt % | | | | |
| EM 4 | Pure water | Graphene | 0.5 | None | | 110 | 25000 |
| | | | wt % | | | | |
| EM 5 | Pure water | Graphene | 0.75 | None | | 125 | 25000 |
| | | | wt % | | | | |
| EM 6 | Pure water | Graphene | 1.0 | None | | 105 | 20000 |
| | | | wt % | | | | |
| EM 7 | Pure water | Graphene | 0.5 | Silicon | 0.05 | 105 | 15000 |
| | | | wt % | | wt % | | |
| EM 8 | Pure water | Graphene | 0.4 | aluminum | 0.1 | 100 | 15000 |
| | | | wt % | oxide | wt % | | |
| | | Carbon | 0.1 | | | | |
| | | black | wt % | | | | |
| EM 9 | Pure water | Carbon | 0.3 | aluminum | 0.1 | 100 | 12000 |
| | | black | wt % | oxide | wt % | | |
| | | | | Iron oxide | 0.1 | | |
| | | | | | wt % | | |
| EM 10 | Pure water | Carbon | 0.3 | Iron oxide | 0.1 | 105 | 12000 |
| | | black | wt % | | wt % | | |
| | | | | Silicon | 0.1 | | |
| | | | | | wt % | | |

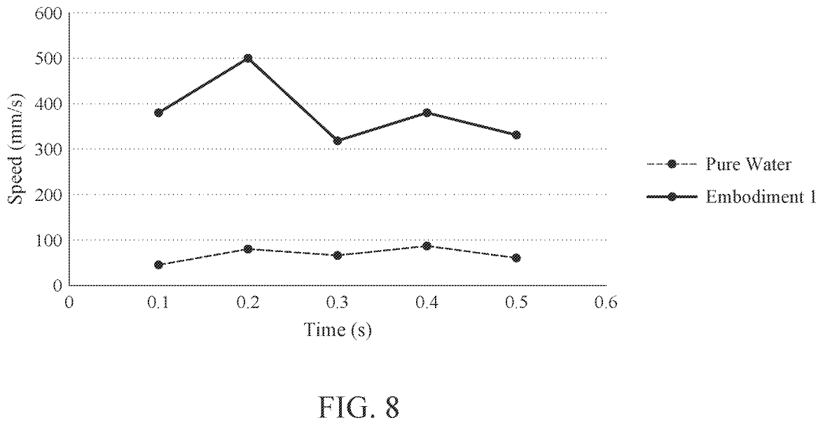

According to the present disclosure, by adding the gas generation substance, a large amount of bubbles or vapor plugs can be generated in the heat transfer fluid in a short period of time to facilitate the movement of the liquid carrier, allowing the heat transfer fluid to flow quickly from the evaporation section to the condensation section, thereby enhancing heat exchange efficiency. Please refer to FIG. 8 which is a graph showing flow velocities of the heat transfer fluids in a pulsating heat pipe according to the first embodiment and a comparative example. Herein, take the configuration of the battery thermal management system 1 in FIG. 1 as an example for illustration. For the battery thermal management system 1 using the heat transfer fluid of Embodiment 1 according to the present disclosure, when the 10 temperature at the evaporation section 210 of the heat pipe 21 is sufficiently high to allow the evaporation of pure water, the gas generation substance is able to facilitate the speed of the heat transfer fluid flow to reach about 389 mm/s within 0.1 seconds once the pure water begins to evaporate. In contrast, for the battery thermal management system 1 using only pure water (comparative example), the speed thereof can only reach about 66 mm/s within 0.1 seconds once the pure water begins to evaporate.

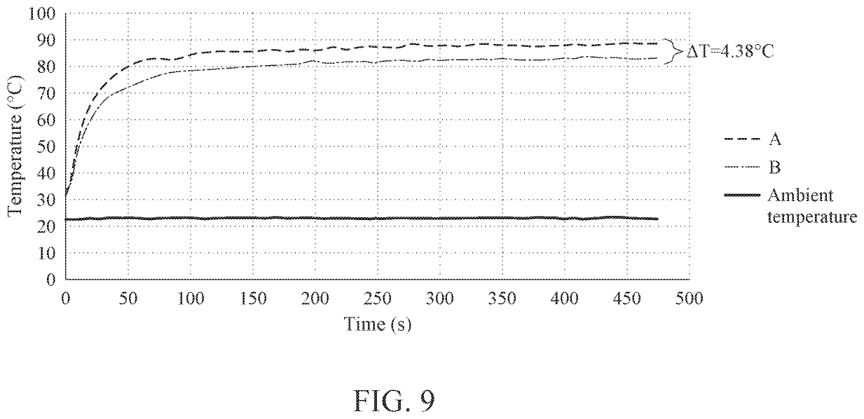

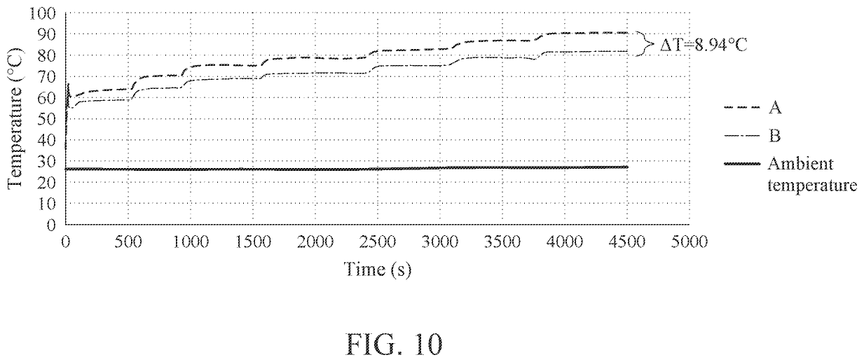

According to the present disclosure, the gas generation substance is helpful to enhance the heat exchange efficiency of the thermal management device, which in turn facilitates a uniform temperature distribution in the battery thermal management system. FIG. 9 is a graph showing the temperature in different positions of the battery thermal management system in FIG. 1 with the heat transfer fluid according to the first embodiment in the pulsating heat pipe. FIG. 10 is a graph showing the temperature in different positions of the battery thermal management system in FIG. 1 with the heat transfer fluid according to the comparative example in the pulsating heat pipe. Herein, take the configuration of the battery thermal management system 1 in FIG. 1 as an example for illustration. The battery thermal management system 1 is constantly at an ambient temperature of about 22° C. to 25° C. Referring to FIG. 9, when the heat transfer fluid according to Embodiment 1 of the present disclosure is provided in the pulsating heat pipe 21, the temperature difference (ΔT) between the center of the battery container 10 (the position annotated A) and the periphery thereof (the position annotated B) nearby the pulsating heat pipe 21 may be only about 4.38° C. In contrast, in FIG. 10, when pure water according to the comparative example is provided in the pulsating heat pipe 21, the temperature difference (ΔT) between the center of the battery container 10 and the periphery thereof nearby the pulsating heat pipe 21 may be a relatively high value of about 8.94ºC.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A heat transfer fluid for thermal management, comprising:
a liquid carrier; and
a gas generation substance distributed in the liquid carrier, wherein the gas generation substance comprises at least one of two-dimensional nanomaterial and three-dimensional nanomaterial.

2. The heat transfer fluid for thermal management according to claim 1, wherein the gas generation substance comprises planar two-dimensional nanomaterial having a thickness of single atomic layer.

3. The heat transfer fluid for thermal management according to claim 1, wherein the gas generation substance comprises at least one of graphene and carbon black.

4. The heat transfer fluid for thermal management according to claim 1, wherein a mass percentage concentration of the gas generation substance in the heat transfer fluid for thermal management ranges from 0.05 wt % to 1.2 wt %.

5. The heat transfer fluid for thermal management according to claim 1, wherein the liquid carrier is selected from the group consisting of pure water, methanol, acetone, ammonia, and combinations thereof.

6. The heat transfer fluid for thermal management according to claim 1, wherein the gas generation substance comprises a first nanomaterial and a second nanomaterial, the first nanomaterial is the at least one of two-dimensional nanomaterial and three-dimensional nanomaterial, and the second nanomaterial is metal oxide nanomaterial or silicon nanomaterial.

7. The heat transfer fluid for thermal management according to claim 6, wherein a mass percentage concentration of the first nanomaterial in the heat transfer fluid for thermal management is greater than a mass percentage concentration of the second nanomaterial in the heat transfer fluid for thermal management.

8. A thermal management device, comprising:
a pulsating heat pipe; and
a heat transfer fluid provided in the pulsating heat pipe, and the heat transfer fluid comprising:
a liquid carrier; and
a gas generation substance distributed in the liquid carrier, wherein the gas generation substance comprises at least one of two-dimensional nanomaterial and three-dimensional nanomaterial.

9. The thermal management device according to claim 8, wherein the gas generation substance comprises planar two-dimensional nanomaterial having a thickness of single atomic layer.

10. The thermal management device according to claim 8, wherein a mass percentage concentration of the gas generation substance in the heat transfer fluid for thermal management ranges from 0.05 wt % to 1.2 wt %.

11. The thermal management device according to claim 8, wherein the gas generation substance comprises a first nanomaterial and a second nanomaterial, the first nanomaterial is the at least one of two-dimensional nanomaterial and three-dimensional nanomaterial, and the second nanomaterial is metal oxide nanomaterial or silicon nanomaterial.

12. The thermal management device according to claim 11, wherein a mass percentage concentration of the first nanomaterial in the heat transfer fluid is greater than a mass percentage concentration of the second nanomaterial in the heat transfer fluid.

13. A battery thermal management system, comprising:
a battery container;
a pulsating heat pipe disposed in the battery container; and
a heat transfer fluid provided in the pulsating heat pipe, and the heat transfer fluid comprising:
a liquid carrier; and
a gas generation substance distributed in the liquid carrier, wherein the gas generation substance comprises nanomaterial.

14. The battery thermal management system according to claim 13, wherein an evaporation section of the pulsating heat pipe is located in the battery container, and the evaporation section is submerged in a coolant in the battery container.

15. The battery thermal management system according to claim 13, further comprising a heat sink in thermal contact with the pulsating heat pipe.

16. The battery thermal management system according to claim 13, wherein the pulsating heat pipe is located between two inner side walls of the battery container, and an evaporation section of the pulsating heat pipe is located in the battery container;
wherein a dimensionless spacing between the two inner side walls is L′, a number of bend at the evaporation section is Ne, and the following condition is satisfied:
$$Ne \leq {L}^{′} / 2.$$

17. The battery thermal management system according to claim 13, wherein the pulsating heat pipe is located between two inner side walls of the battery container, and a condensation section of the pulsating heat pipe protrudes out of the battery container;
wherein a dimensionless spacing between the two inner side walls is L′, a number of bend at the condensation section is Nc, and the following condition is satisfied:
$$Nc \leq {L}^{′} / 2.$$

18. The battery thermal management system according to claim 13, wherein the gas generation substance comprises at least one of graphene and carbon black.

19. The battery thermal management system according to claim 13, wherein a mass percentage concentration of the gas generation substance in the heat transfer fluid for thermal management ranges from 0.05 wt % to 1.2 wt %.

20. The battery thermal management system according to claim 13, wherein the gas generation substance comprises a first nanomaterial and a second nanomaterial, and the second nanomaterial is metal oxide nanomaterial or silicon nanomaterial.

21. The battery thermal management system according to claim 20, wherein a mass percentage concentration of the first nanomaterial in the heat transfer fluid is greater than a mass percentage concentration of the second nanomaterial in the heat transfer fluid.
